(19) United States
(12) Patent Application Publication
(10) Pub. No.: US 2014/0359624 A1
(43) Pub. Date: Dec. 4, 2014

(54) DETERMINING A COMPLETION TIME OF A JOB IN A DISTRIBUTED NETWORK ENVIRONMENT

(71) Applicant: HEWLETT-PACKARD DEVELOPMENT COMPANY, L.P., Houston, TX (US)

(72) Inventors: Ludmila Cherkasova, Sunnyvale, CA (US); Zhuoyao Zhang, Palo Alto, CA (US)

(21) Appl. No.: 13/905,571

(22) Filed: May 30, 2013

(51) Int. Cl. G06F 9/44

(52) U.S. Cl. CPC G06F 9/44
USPC 718/100

(57) ABSTRACT

Determining a completion time of a job in a distributed network environment, the method includes determining completion times of a map task and a reduce task of a job and executing at least one test to collect a training dataset that characterizes the completion times of the map task and the reduce task.

### BACKGROUND

A distributed network environment uses a number of nodes to access, process, and store jobs. By distributing jobs across multiple nodes, the distributed network environment operates as a single system to access, process, and store jobs at a high processing rate. Further, determining a completion time of a job in a distributed network environment allows a distributed network environment to manage a number of jobs distributed across multiple nodes, central processing units, network links, disk drives, or other resources.

### BRIEF DESCRIPTION OF THE DRAWINGS

The accompanying drawings illustrate various examples of the principles described herein and are a part of the specification. The examples do not limit the scope of the claims.

FIG. 1 is a diagram of an example of a distributed network environment, according to one example of principles described herein.

FIG. 2 is a diagram of an example of a MapReduce pipeline, according to one example of principles described herein.

FIG. 3 is a diagram of an example of a training dataset for a read procedure, according to one example of principles described herein.

FIG. 4 is a flowchart of an example of a method for determining a completion time of a job in a distributed network environment, according to one example of principles described herein.

FIG. 5 is a flowchart of an example of a method for determining a completion time of a job in a distributed network environment, according to one example of principles described herein.

FIG. 6 is a diagram of an example of a completion time system, according to one example of principles described herein.

FIG. 7 is a diagram of an example of a completion time system, according to one example of principles described herein.

Throughout the drawings, identical reference numbers designate similar, but not necessarily identical, elements.

### DETAILED DESCRIPTION

With the increased scale of the number of nodes, central processing units, network links, disk drives, or other resources in a distributed network environment, determining an accurate completion time of a job becomes increasingly more difficult. Determined completion times are used to manage jobs in a distributed network environment in a given amount of time, but if the determined completion times are inaccurate, the ability to effectively manage these jobs is negatively impacted.

To determine a completion time for a job, a distributed network environment uses past job completion times to create a job profile for a small data sample. A past job completion time may include a completion time of a map task and a reduce task for the past job. The completion times of the map task and the reduce task for the past job are analyzed. From the analyzed completion times of the map task and the reduce task, a scaling factor is used to create a job profile and to determine completion times for a job having a large data sample. Further, monitoring and job profiling techniques are used to create a job profile. The monitoring and job profiling techniques introduce overhead into the distributed network environment.

Using a job profile and a scaling factor to determine completion times for a future job having a larger data sample may lead to an inaccurate completion time for a job having a large data sample. For example, as the amount of data for a job increases, completion times for a map task and a reduce task may not increase linearly. As a result, the scaling factor may inaccurately determine a completion time for a job having a very large amount of data to process. Thus, larger overhead may also lead to an inaccurate completion time for a job having a larger data sample.

The principles described herein include a method and a system for determining completion times of a job in a distributed network environment. The system and the method determine a completion time of a job in a distributed network environment by creating a MapReduce performance model. The MapReduce performance model is used to efficiently predict the completion time of a job. As will be described below, the MapReduce performance model combines a useful rationale of a platform profiling method to more accurately determine completion times of map tasks and reduce tasks. Further, the completion time of a map task and a reduce task include specific, well defined data processing procedures. The completion time depends on the amount of data processed by the map task and the reduce task as well as the performance of the distributed network environment.

Further, the map task and the reduce task have a constant overhead for setting and cleaning up. In one example, the overhead is accounted separately for each map task and each reduce task. Further, for a more accurate MapReduce performance model, it is desirable to minimize the overhead introduced by additional monitoring and profiling techniques. As will be described below, counters can be used to minimize the overhead introduced by additional monitoring and profiling techniques.

As will be described below, a method for determining a completion time of a job in a distributed network environment includes determining a completion time for a map task and a reduce task of a job and executing at least one test to collect a training dataset that characterizes the completion time of the map task and the reduce task.

A job is a computer application or program that is set up to run to completion without manual intervention. Thus, all the input data is preselected through scripts, command line parameters, job control language, or combinations thereof.

A map task may be a procedure that takes input data, such as a job, and divides the input data into smaller sub-procedures by distributing the input data on a number of nodes. A map task may be a read procedure, a collect procedure, a spill procedure, a merge procedure, or combinations thereof. More details about the map task will be described below.

A reduce task may be a procedure that collects data from the map tasks, combines data from the map tasks, and outputs the data. A reduce task may be a shuffle procedure, a write procedure, or combinations thereof. More details about the reduce task will be described below. A completion time is the overall time a distributed network environment takes to complete a job.

Further, as used in the present specification and in the appended claims, the term “a number of” or similar language is meant to be understood broadly as any positive number including 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

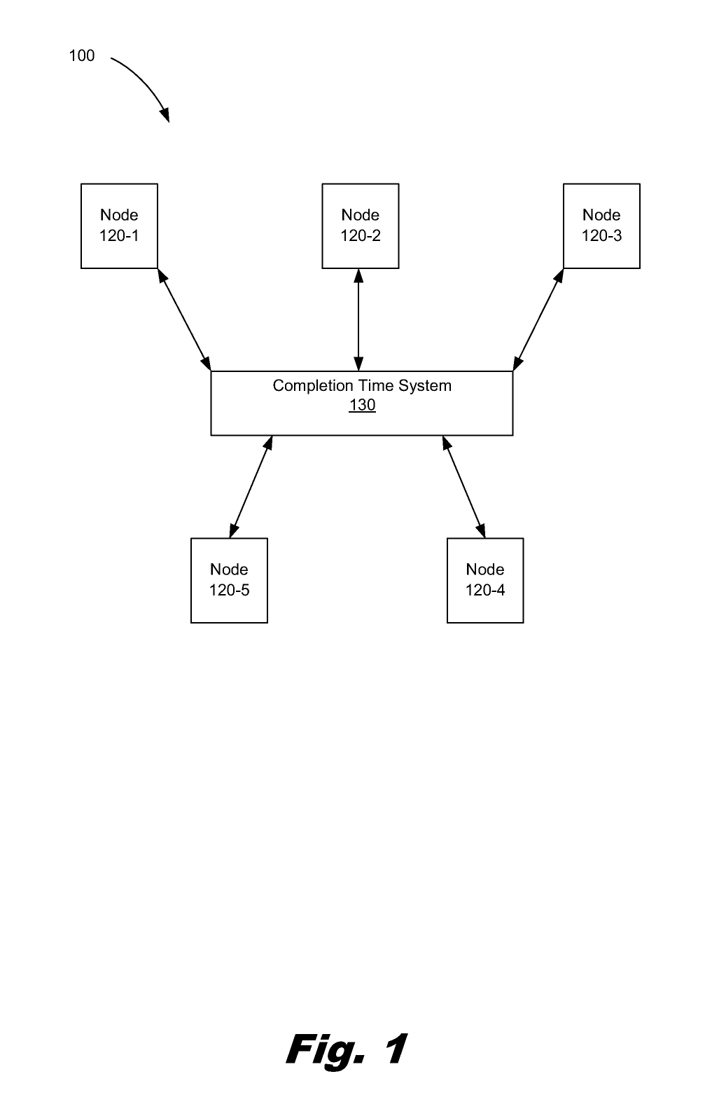

Referring now to the figures, FIG. 1 is a diagram of an example of a distributed network environment, according to one example of principles described herein. As mentioned above, a MapReduce performance model is used to efficiently determine the completion time of a job. As will be described below and in later parts of the specification, the MapReduce performance model combines a useful rationale of a platform profiling method and an analytical model. The rationale of a platform profiling method is used to more accurately determine a completion time for map tasks and reduce tasks. In one example, the execution of a map task and a reduce task include specific, well defined data processing procedures. The completion time depends on the amount of data processed by the map task and the reduce task as well as the performance of the distributed network environment. In one example, a map task and a reduce task are specific and their computations are user defined for different jobs.

As mentioned above, a distributed network environment (100) uses a number of nodes (120) to access, process, and store large amounts of data such as a job. In one example, the distributed network environment (100) uses five nodes (120). In this example, the distributed network environment's nodes (FIG. 1, 120) use similar hardware and a similar distributed network environment arrangement as a distributed network environment having a larger number of nodes. In practice, the number of nodes (120) may be the same or vary depending on the intended application. As mentioned above, a job is distributed across multiple nodes (120), central processing units, network links, disk drives, other resources, or combinations thereof. This allows the job to achieve optimal resource utilization, minimized response time, maximum throughput, and to avoid overloading any single node. By distributing the job across multiple nodes (120), the distributed network environment (100) operates as a single entity to access, process, and store large amounts of data at a high performance rate. While this example has been described with reference to a specific number of nodes, any appropriate number of nodes may be used in accordance with the principles described herein.

The distributed network environment (100) further includes a completion time system (130). The completion time system (130) is used to predict a job completion time in a distributed network environment.

As will be described below, the completion time system (130) determines a completion time for a map task for a given job. The map task may include a number of procedures such as a read procedure, a collect procedure, a spill procedure, and/or a merge procedure. More information about the map task will be described below. While the map task has been described with reference to specific types of procedures, any appropriate type of procedure for a map task may be used in accordance with the principles described herein.

The completion time system (130) determines a completion time for a reduce task of the job. The reduce tasks may include a number of procedures such as a shuffle procedure and a write procedure. More information about the reduce task will be described below. While the reduce task has been described with reference to specific types of procedures, any appropriate type of procedure for a reduce task may be used in accordance with the principles described herein.

Further, the completion time system (130) executes at least one test to collect a training dataset that characterizes the completion time for the map task and the reduce task. The training dataset is collected by varying a number of parameters that affect the parameters of the map task and the parameters of the reduce task. More information about the training dataset will be described below.

The completion time system (130) creates a platform profile to characterize a profile completion time for the map task and the reduce task as a function of processed data. More information about the platform profile will be described below.

The completion time system (130) creates a platform performance model based on the platform profile. In one example, the platform performance model is created using the training dataset and a linear regression technique to determine a completion time for the map task and the reduce task as a function of processed data. More information about the platform performance model will be described below.

The completion time system (130) creates a compact job profile for each job. The compact job profile summarizes a past job's properties and performance. More information about the compact job profile will be described below.

The completion time system (130) creates a MapReduce performance model based on the platform profile and the platform performance model to determine the completion time of the given job in the distributed network system (100). The platform performance model is created once and reused for determining completion times of a job for a number of applications. As a result, the completion time system (130) determines the completion time of the job in a distributed network environment. More information about the performance model will be described below.

While this example has been described with reference to the time completion system being located in the distributed network environment, the time completion system may be located in any appropriate location according to the principles described herein. For example, the time completion system may be located on a user device. In another example, the time completion system may be located at a location over a network or distributed across the network.

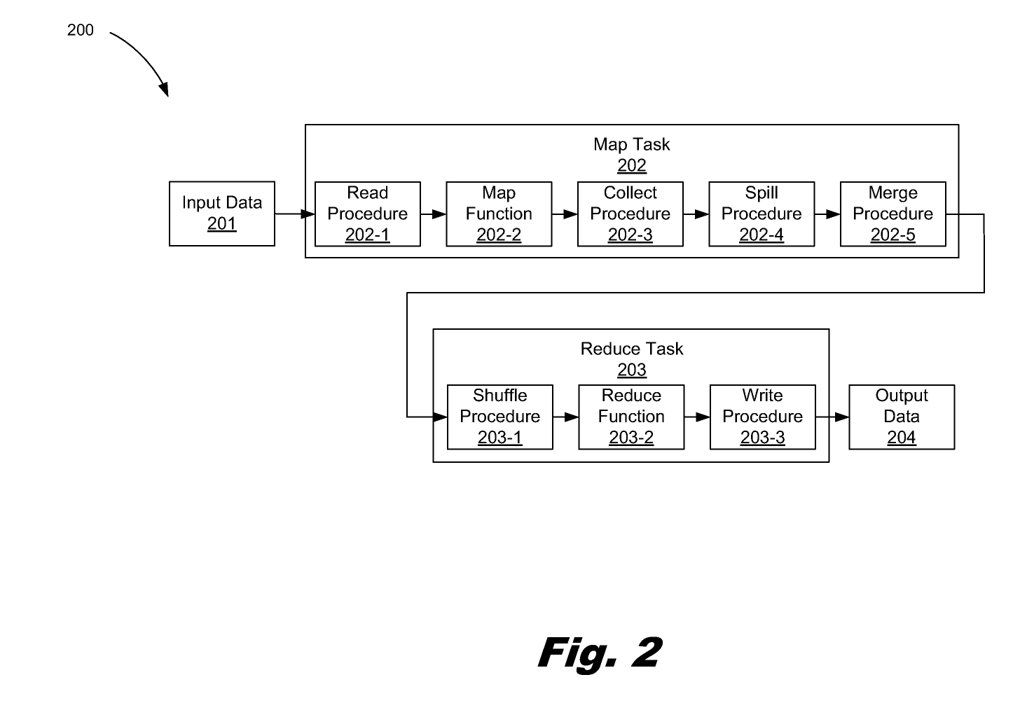

FIG. 2 is a diagram of an example of a MapReduce pipeline (200), according to one example of principles described herein. As will be described below, input data is sent to a map task. The input data is processed by a number of procedures in the map task such as a read procedure, a map function procedure, a collect procedure, a spill procedure, and a merge procedure. Further, the data from the map task's output is sent to a reduce task. As mentioned above, a reduce task may include a number of procedures such as a shuffle procedure, a reduce function procedure, and a write procedure. As a result, the input data is processed by the MapReduce pipeline.

As mentioned above, a read procedure (202-1) reads input data (201). In one example, input data (201) may be of varying sizes. As will be described below, during a read procedure (202-1), the read procedure (202-1) reads the input data (201). Further, a read procedure's completion time is a measure of the duration of the read procedure as a function of the amount of input data (201) read by the read procedure (202-1).

The read procedure sends the input data (201) to the map function (202-2). A collect procedure (202-3) buffers the map function (202-2) outputs into memory and produces intermediate data. As will be described below, during a collect procedure (202-3) the collect procedure's completion time is based on the time it takes to buffer a map's user defined function outputs into memory and the amount of generated intermediate data.

The intermediate data is then sent to a spill procedure (202-4). The spill procedure (202-4) locally sorts the intermediate data from the collect procedure (202-3) and partitions the intermediate data from the collect procedure (202-3) for different reduce tasks and then writes the intermediate data to a local disk. As will be described below, during a spill procedure (202-4), the spill procedure's completion time is measured from the time taken to locally sort the intermediate data from the collect procedure (202-3) and partition the intermediate data from the collect procedure (202-3) for different reduce tasks and then writing the intermediate data to a local disk.

Next, a merge procedure (202-5) merges different spill files from the spill procedure (202-4) into a single spill file for each reduce task. As will be described below, during a merge procedure (202-5), the merge procedure's completion time is measured from the time for merging different spill files into a single spill file for each reduce task.

A shuffle procedure (203-1) transfers the intermediate data from the collect procedure (202-3) of the map task (202) to a reduce task (203). Further, the shuffle procedure (203-1) merge-sorts the intermediate data. As will be described below, during a shuffle procedure (203-1), the shuffle procedure's completion time is measured from the time taken to transfer intermediate data from the collect procedure (202-3) of the map task (202) to a reduce task (203) and merge the intermediate data.

The intermediate data is then sent to a write procedure (203-3). A write procedure (203-3) writes the output of a reduce task to a distributed file system. This data is the output data (204). As will be described below, during a write procedure (203-3), the write procedure's completion time is measured from the amount of time taken to write the output of a reduce task to a distributed file system.

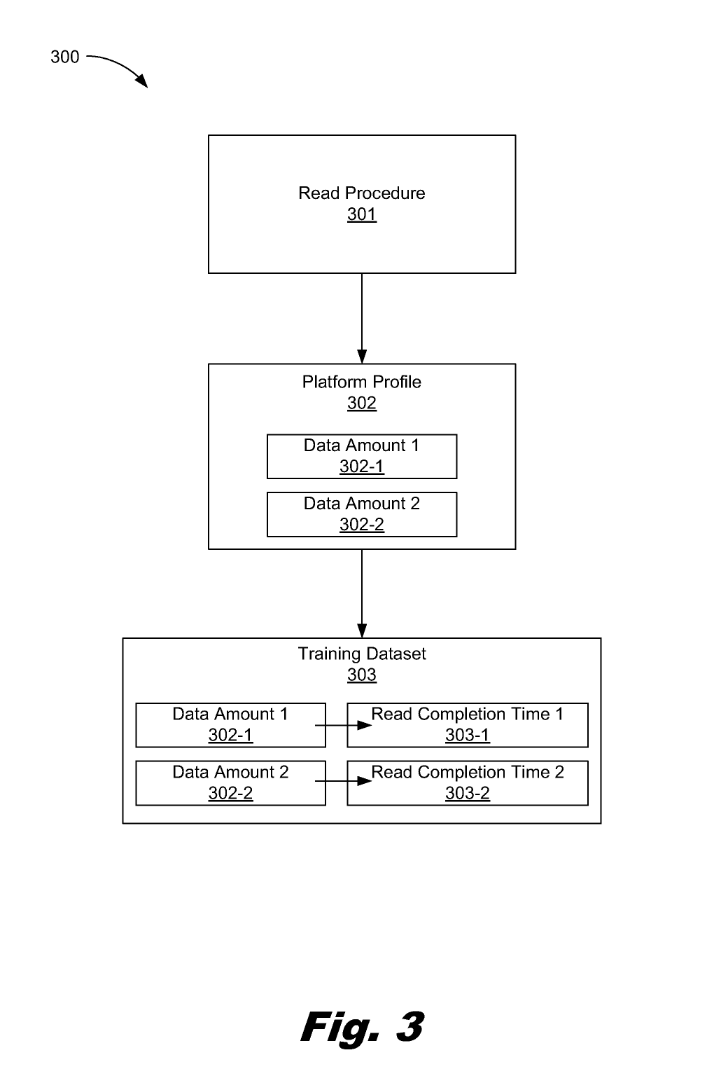

FIG. 3 is a diagram of an example of a training dataset for a read procedure, according to one example of principles described herein. As mentioned above, the completion time system (FIG. 1, 130) collects a training dataset that characterizes the completion time for a map task and a reduce task. The training dataset is collected by varying a number of parameters that affect the performance of the map tasks and reduce tasks. In one example, the amount of data in a map task or a reduce task is used to vary the performance of a distributed network environment.

As mentioned above, a platform profile is used to characterize completion times for a map task and a reduce task as a function of processed data. Turning specifically to FIG. 3, a platform profile (302) is used to characterize a completion time for a read procedure (301). The platform profile (302) has two different data amounts, data amount 1 (302-1) and data amount 2 (302-2), that are used for a read procedure. In one example, during a read procedure, the completion time is a measure of the amount of data read by the read procedure. In keeping with the given example, a training dataset (303) characterizes a completion time for a read procedure (301). In this example, if a read procedure reads data amount 1 (302-1), the read procedure will have a completion time 1 (303-1). Further, if a read procedure reads data amount 2 (302-2), the read procedure will have a read completion time 2 (303-2).

As a result, a job having a read procedure similar to data amount 1 (302-1) can use the training dataset (303) to determine if the job will have a completion time for a read procedure similar to read completion time 1 (303-1). Similarly, a job having a read procedure similar to data amount 2 (302-2) can use the training dataset (303) to determine if the job will have a completion time for a read procedure similar to read completion time 2 (303-2).

While FIG. 3 is an example of a training dataset for a read procedure, the training dataset can be used for any map task or any reduce task. Although two different data amounts are used to characterize read completion times in the example of FIG. 3, in practice a number of different data amounts may be used.

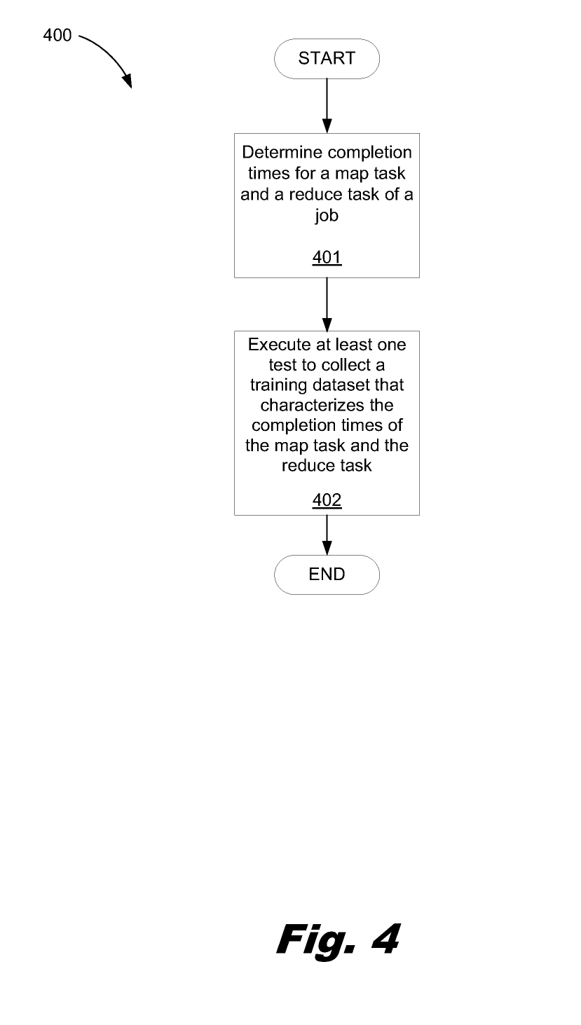

FIG. 4 is a flowchart of an example of a method (400) for determining a completion time of a job in a distributed network environment, according to one example of principles described herein. As mentioned above, the time completion system (FIG. 1, 130) is used to determine a completion time of a job in a distributed network environment. The method (400) for determining a completion time of a job in a distributed network environment includes determining (401) a completion time for a map task and a reduce task of a job, and executing (402) at least one test to collect a training dataset that characterizes the completion time of the map task and the reduce task.

Turning specifically to FIG. 4, determining a completion time of a map task of a job includes determining a completion time for a read procedure, a collect procedure, a spill procedure, and a merge procedure. In one example, a read procedure reads a block of data, such as sixty four megabytes (MB), from a distributed file system. In another example, a read procedure reads a block of data of an arbitrary size such as seventy MB. In this example, the read procedure uses two blocks of data: one block of data of sixty four MB and a second block of data of six MB. As a result, a read procedure may read data of varying sizes. During a read procedure, the read procedure's completion time is a measure of the duration of a read procedure as a function of the amount of data read by the read procedure.

As mentioned above, determining a completion time of a map task of a job includes determining a completion time of a collect procedure. During a collect procedure, the collect procedure's completion time is based on the time it takes to buffer a map user defined function outputs into memory and the amount of generated intermediate data.

As mentioned above, determining a completion time of a map task of a job includes determining a completion time of a spill procedure. During a spill procedure, the spill procedure's completion time is measured from the time taken to locally sort the intermediate data from the collect procedure and partition the intermediate data from the collect procedure for different reduce tasks and then writing the intermediate data to a local disk.

Determining a completion time of a map task of a job includes determining a completion time of a merge procedure. During a merge procedure, the merge procedure's completion time is measured from the time for merging different spill files into a single spill file for each reduce task. Further, any combinations of the above completion times may be used to determine a completion time of a map task of a job.

As mentioned above, the method includes determining a completion time of a reduce task for a job. A completion time of a reduce task for a job includes determining a completion time of a shuffle procedure and a write procedure.

During a shuffle procedure, the shuffle procedure's completion time is measured from the time taken to transfer intermediate data from the collect procedures of the map task to a reduce task and merge-sort the data. In this example, the shuffle procedure and the merge-sort procedure are combined because in one implementation of a distributed network system (FIG. 1, 100) these two sub-procedures are interleaved. Further, the processing time of the shuffle procedure depends on the amount of intermediate data for each reduce task and parameters of the distributed network system (FIG. 1, 100).

In one example, a shuffle procedure is allocated seven hundred MB of random access memory (RAM). In this example, the distributed network system sets a limit of forty six percent of allocated memory for an in-memory sort buffer. The portions of shuffled intermediate data are merge-sorted in memory, and a spill file of three hundred twenty MB is written to a hard drive disk. After all the intermediate data is shuffled, the distributed network system merge-sorts the first ten spill files and writes the spilled files to a new sorted file. The distributed network system merge-sorts the next ten spill files and writes the next ten spill files in the next new sorted file on the hard drive disk. At the end, the shuffle procedure merge-sorts all the spill files. As a result, a number of different scaling factors for the completion time of the shuffle procedures are observed when intermediate datasets per reduce task are larger than 3.2 gigabytes (GB) in the distributed network system. For a different distributed network system, scaling factors can be similarly determined from the distributed network system parameters.

Determining a completion time of a reduce task of the job further includes determining a completion time of a write procedure. During a write procedure, the write procedure's completion time is measured from the amount of time taken to write the output data of a reduce task to a distributed file system. Further, any combinations of the above completion times may be used to determine a completion time of a reduce task of a job.

As mentioned above, the method includes executing (302) at least one test to collect a training dataset that characterizes the completion time of the map task and the reduce task. In one example, a training dataset is a set of parameterizable tests to measure and profile different map tasks and reduce tasks given a number of nodes in a distributed network system. As depicted in FIG. 1, at least one test may be executed in a distributed network system (FIG. 1, 100) having five nodes (FIG. 1, 120). In this example, the distributed network system nodes (FIG. 1, 120) use similar hardware and distributed network system arrangement as a distributed network system with a greater number of nodes. Further, collecting a training dataset using at least one test does not interfere with the current jobs executing on the distributed network environment. As a result, determining a completion time of a job can be performed much faster while testing a large set of diverse processing patterns. As will be described below, the input parameters of the test impact the amount of data processed by different map tasks and reduce tasks. Further, at least one test includes a specified number of map tasks and reduce tasks. Additionally, each test uses input data with each record consisting of one hundred bytes of synthetic data. The map tasks emit input records according to map selectivity for each test.

As mentioned above, at least one test is executed to collect a training dataset that characterizes the completion time of the map task and the reduce task for processing different data amounts on a given distributed network system (FIG. 1, 100) by varying a number of parameters.

In one example, a parameter that can be varied is an input size per map task. The input size per map task controls the size of an input read by each map task. As a result, the input size per map task profiles a completion time for a read procedure processing different amounts of data.

In another example, a parameter that can be varied is map selectivity. Map selectivity defines the ratio of a user defined map function's output to a map function input. Further, map selectivity controls the amount of data produced as the output of the user defined map function and directly affects the collect procedure, spill procedure, and the merge procedure completion times for the map task. The map task's output further determines the overall amount of data produced for processing by the reduce task. As a result, the map selectivity impacts the amount of data processed by the shuffle procedure and impacts a completion time of a reduce task.

In yet another example, a parameter that can be varied is the number of map tasks. The number of map tasks expedites the generation of a large amount of intermediate data for each reduce task.

In yet another example, a parameter that can be varied is a number of reduce tasks. The number of reduce tasks expedites the training dataset generation with large amounts of intermediate data for each reduce task.

While the examples described above are described with reference to specific mechanisms for varying a number of parameters, any mechanism may be used to vary a number of parameters to execute at least one test to collect a training dataset that characterizes the completion time of a map task and a reduce task. For example, multiple combinations of examples described above can be combined to vary the number of parameters or otherwise used to determine the completion times.

In keeping with the given example above, a test with forty map tasks and forty reduce tasks can be executed using five nodes. In this example, the test is executed by varying a number of parameters. For example, the input size per map task is varied as follows for six tests. For test one, the input size per map task is two MB. For test two, the input size per map task is four MB. For test three, the input size per map task is eight MB. For test four, the input size per map task is sixteen MB. For test five, the input size per map task is thirty two MB. For test six, the input size per map task is sixty four MB.

In keeping with the given example, the map selectivity is set to a ratio of 0.2, 0.6, 1.0, 1.4, and 1.8 respectively for each test. The tests can generate special ranges of intermediate data for each reduce task for accurate characterization of a shuffle procedure.

In one example, the tests are defined by the number of map tasks ranging from twenty map tasks to one hundred sixty map tasks. The input size per map task is sixty four MB, the map selectivity task is five, and the number of reduce tasks is five. As a result, the tests have different intermediate data sizes per reduce task ranging from one GB to twelve GB.

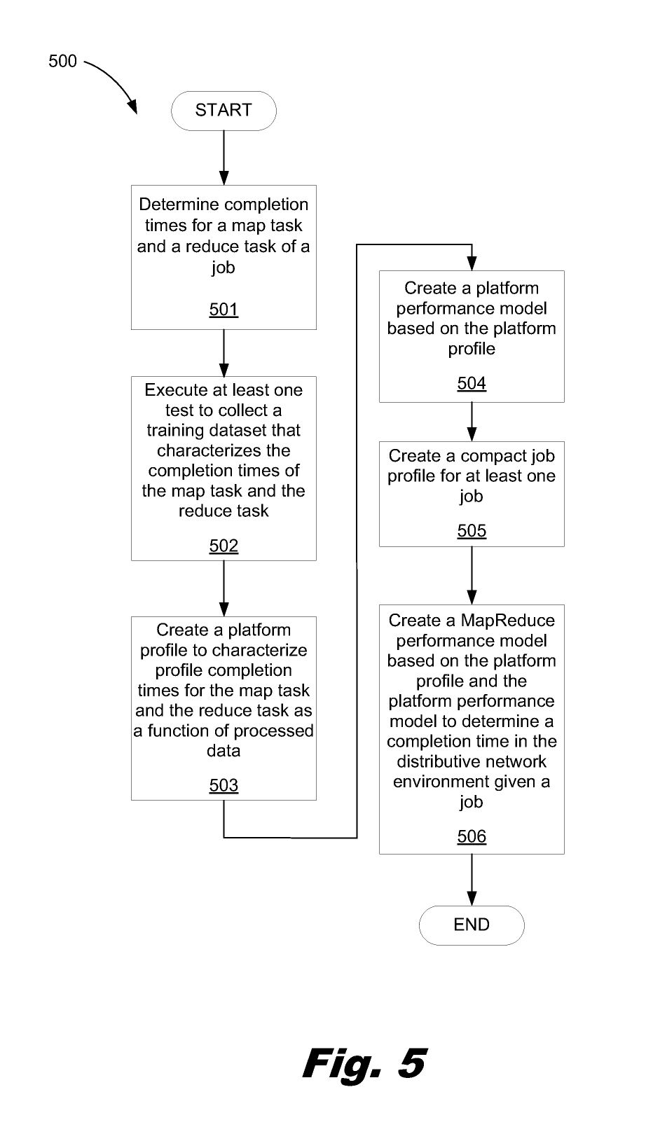

FIG. 5 is a flowchart of an example of a method for determining a completion time of a job in a distributed network environment, according to one example of principles described herein. As mentioned above, the time completion system (FIG. 1, 130) is used to determine a completion time of a job in a distributed network environment. The method to determine a completion time of a job in a distributed network environment includes determining (501) a completion time for a map task and a reduce task of a job, executing (502) at least one test to collect a training dataset that characterizes completion times of the map task and the reduce task, creating (503) a platform profile to characterize a profile completion time for the map task and the reduce task as a function of processed data, creating (504) a platform performance model based on the platform profile, creating (505) a compact job profile for at least one job, and creating (506) a MapReduce performance model based on the platform profile to determine a completion time in the distributed network environment given a job.

Creating a platform profile to characterize profile completion times for the map task and the reduce task as a function of processed data can include using at least one test to collect a dataset. As mentioned above, a dataset is collected for the amount of processed data for the map tasks and the reduce tasks. The dataset from at least one test defines the platform profile that is later used as the training dataset for a platform performance model.

In one example, the training dataset for a platform profile uses a map task. As mentioned above, a training dataset characterizes the completion time for a map task. In another example, the training dataset for a platform profile characterizes the completion time for a reduce task.

As mentioned above, the method includes creating (504) a platform performance model based on the platform profile. In one example, creating a platform performance model based on the platform profile includes using a training dataset and a robust linear regression to derive a platform performance model that estimates a completion time for each map task and each reduce task as a function of processed data.

Further, to create a platform performance model, a relationship between the amount of data processed and the completion time of each map task and reduce task is determined using the training dataset as described above.

In one example, six sub-models define relationships for a read procedure, a collect procedure, a spill procedure, a merge procedure, a shuffle procedure, and a write procedure respectively in a five node distributed network environment. In this example, to derive the six sub-models, the platform profile is used and a set of equations which express a map task and a reduce task is formed as a linear function of processed data. In keeping with the given example, a method for solving such a set of equations may be a non-negative least squares regression. Although a non-negative least squares regression may be used, a robust linear regression may be used to improve the overall accuracy of the platform performance model.

To evaluate the accuracy and fit of a platform performance model, a prediction error for each data entry in a training dataset is computed. In one example, a prediction error may be a measured completion time minus a predicted completion time divided by the measured completion time. As a result, a predicted completion time may be predicted within an amount of a measured completion time.

In one example for a read procedure, sixty six percent of map tasks had a relative error less than ten percent. Further, ninety two percent of map tasks had a relative error less than twenty percent. In one example of a shuffle procedure, seventy six percent of reduce tasks had a relative error less than ten percent. Further, ninety six percent of reduce tasks had a relative error less than twenty percent. As a result, the platform performance model having an accuracy as described above is determined to fit the training dataset.

Further, a test may be implemented to verify whether two linear functions provide a better fit for approximating different parts of the training data ordered by the increasing data amount instead of a single linear function derived on all data. For example, the shuffle procedure may be better approximated by a combination of two linear functions over two data ranges. For example, one of the two data ranges may be less than 3.2 GB, and the other data range may be larger than 3.2 GB.

In one example, compact job profiles summarize a job's properties and performance of a user defined map and reduce functions. Further, the compact job profile captures a job's inherent properties such as a job's map selectivity and/or a job's reduce selectivity. The job's map selectivity and/or a job's reduce selectivity is the ratio of the user defined map function or user defined reduce function output to the map function input and/or reduce function input.

As mentioned above, the method includes creating a MapReduce performance model based on the platform profile to determine a completion time in the distributed network environment given a job. Creating such a MapReduce performance model includes combining the knowledge of a compact job profile and the platform performance model to determine the overall completion time of the job.

To create a MapReduce performance model, an analytical model is used to validate the model. In one example, the MapReduce performance model utilizes data about the average and maximum completion times of map tasks and reduce tasks for determining a lower bound and an upper bound on a completion time for a job as a function of allocated resources. In this example, the allocated resources may be map slots and reduce slots. In another example, the completion time is based on the average of the lower bound and the upper bound, which serves as an accurate analytical model to determine the completion time of a job. In this example, the analytical model can determine completion times within ten percent of a measured completion time for a job.

Further, to apply the analytical model to create a MapReduce performance model, an estimate of the average and maximum of completion time for a map task and a reduce task are used. In one example, the map completion time depends on a user defined map function and is estimated according to the number of input records and an execution time per record. Depending on the average and maximum input data size, the average and maximum completion times can be determined.

Further, for a map task, the completion time is estimated as a sum of durations of all the map tasks. In one example, the completion time for a read procedure, a collect procedure, a spill procedure, and a merge procedure are estimated according to the platform performance model described above by applying a corresponding function to the data amount processed by each procedure. In one example, the amount of data for a collect procedure, a spill procedure, and a merge procedure are estimated by applying a map selectivity parameter to a map task input data size. Further, this information can be available in the compact job profile.

Additionally, for a reduce task, the completion time is estimated as a sum of completion times of a shuffle procedure and a write procedure. Similarly, to the map tasks described above, the completion times of the shuffle procedure and the write procedure are estimated according to the platform performance model and the input data size for each procedure listed above. Alternatively, the completion time is estimated according to the number of reduce records and the execution time per record available from the compact job profile.

Apart from the map tasks and reduce tasks described above, each map task and/or reduce task have a constant overhead for setting and cleaning up. In one example, the overhead is accounted separately for each map task and/or reduce task. Further, for a more accurate MapReduce performance model, it is desirable to minimize the overhead introduced by an additional monitoring and profiling technique.

In one example, to minimize the overhead introduced by an additional monitoring and profiling technique, an accurate performance model includes several counters. The counters may count the number of bytes read and written in a job. Further, a more accurate MapReduce performance model can be realized by adding counters that measure completion times of the map tasks and reduce tasks to an existing counter reporting mechanism. As a result, a more accurate MapReduce performance model can activate a subset of counters for collecting a set of measurements for each map task and each reduce task.

In another example, a MapReduce performance model may implement a profiling tool based on BTrace. BTrace is a dynamic instrumentation tool for Java that is publically available under the general public license of the Free Software Foundation, Inc. located in Boston, Mass., U.S.A. Further, using BTrace for a more accurate MapReduce performance model is desirable because BTrace has zero overhead when monitoring is turned off. However, in general, the dynamic instrumentation overhead is significantly higher compared to adding counters. As a result, BTrace can be used to measure completion times of the user defined map functions and reduce functions.

FIG. 6 is a diagram of an example of a completion time system (600), according to one example of principles described herein. The completion time system (600) includes a determination engine (602), an execution engine (604), and a creation engine (606). In this example, the completion time system (600) further includes a variation engine (608). The engines (602, 604, 606, 608) refer to a combination of hardware and program instructions to perform a designated function. Each of the engines (602, 604, 606, 608) may include a processor and memory. The program instructions are stored in the memory and cause the processor to execute the designated function of the engine.

The determination engine (602) is used to determine a completion time of a map task. As mentioned above, a map task may be a read procedure, a collect procedure, a spill procedure, a merge procedure, another type of procedure, or combinations thereof. Further, a completion time is determined for each of the map tasks above. The determination engine (602) is used to further determine a completion time of a reduce task. As mentioned above, a reduce task may be a shuffle procedure, a write procedure, another type of procedure, or combinations thereof. Further, a completion time is determined for each of the reduce tasks above.

The execution engine (604) is used to execute at least one test as a training dataset. As mentioned above, a training dataset is a set of parameterizable tests to measure and profile different map tasks and reduce tasks given a number of nodes in a distributed network system.

The creation engine (606) is used to create a platform profile. As mentioned above, the platform profile using a training dataset and a robust linear regression to derive a platform performance model to estimate a completion time as a function of processed data for each map task and reduce task.

The creation engine (606) is used to further create a platform performance model based on the platform profile. As mentioned above, a platform profile is used to create a platform performance model. A set of tests is executed, which measures the completion times of the map task and the reduce tasks for processing different amount of data.

The creation engine (606) is used to further create a compact job profile for each job. As mentioned above, the compact job profile summarizes a past job's properties and performance.

The creation engine (606) is used to further create a MapReduce performance model. As mentioned above, the MapReduce performance model includes combining the knowledge of an extracted job profile and the platform performance model to determine the completion time of a job.

The variation engine (608) is used to vary parameters in at least one test. As mentioned above, at least one test is performed to characterize completion times of map tasks and reduce tasks by processing different data amounts on a given distributed network system by varying a number of parameters. As mentioned above, parameters that may be varied include input size of map task, map selectivity, a number of map tasks, a number of reduce tasks, and combinations thereof.

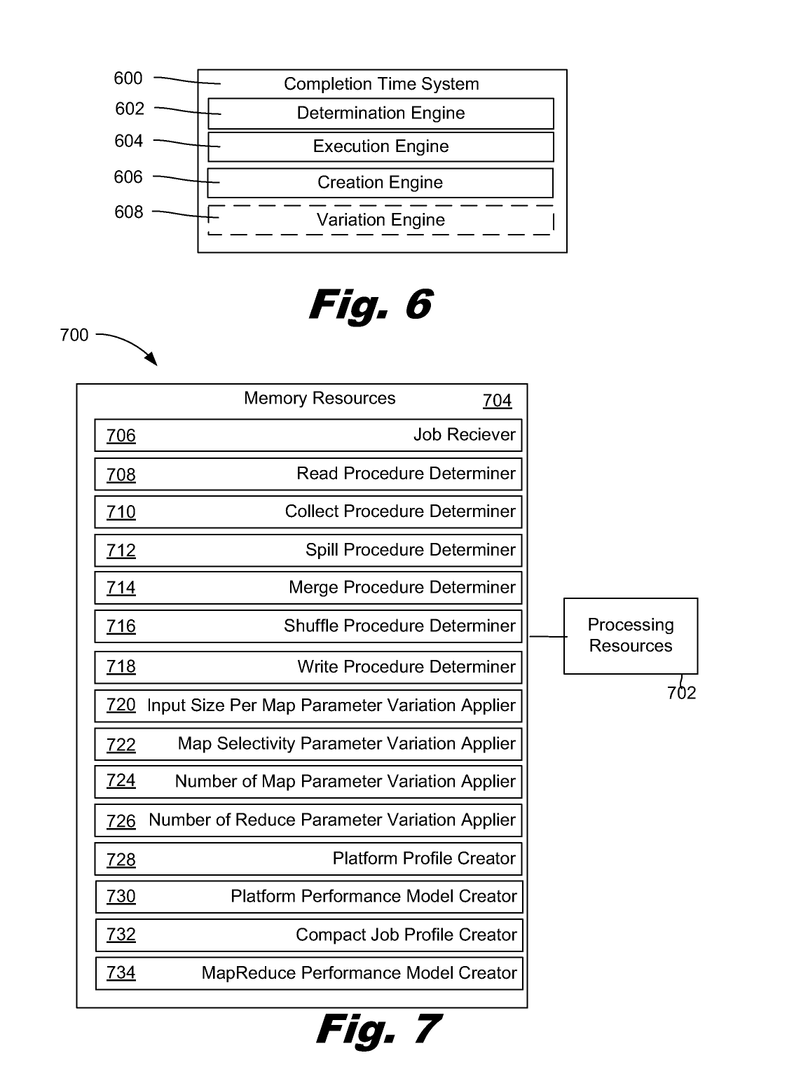

FIG. 7 is a diagram of an example of a time completion system (700), according to one example of principles described herein. In this example, the time completion system (700) includes processing resources (702) that are in communication with memory resources (704). Processing resources (702) include at least one processor and other resources used to process programmed instructions. The memory resources (704) represent generally any memory capable of storing data such as programmed instructions or data structures used by the time completion system (700). The programmed instructions shown stored in the memory resources (704) include a job receiver (706), a read procedure determiner (708), a collect procedure determiner (710), a spill procedure determiner (712), a merge procedure determiner (714), a shuffle procedure determiner (716), a write procedure determiner (718), an input per map parameter variation applier (720), a map selectivity parameter variation applier (722), a number of map parameter variation applier (724), a number of reduce parameter variation applier (726), a platform profile creator (728), a platform performance model creator (730), a compact job profile creator (732), and a MapReduce performance model creator (734).

The memory resources (704) include a computer readable storage medium that contains computer readable program code to cause tasks to be executed by the processing resources (702). The computer readable storage medium may be tangible and/or physical storage medium. The computer readable storage medium may be any appropriate storage medium that is not a transmission storage medium. A non-exhaustive list of computer readable storage medium types includes non-volatile memory, volatile memory, random access memory, write only memory, flash memory, electrically erasable program read only memory, or types of memory, or combinations thereof.

The job receiver (706) represents programmed instructions that, when executed, cause the processing resources (702) to receive a job. The read procedure determiner (708) represents programmed instructions that, when executed, cause the processing resources (702) to determine a completion time for a read procedure. The collect procedure determiner (710) represents programmed instructions that, when executed, cause the processing resources (702) to determine a completion time for the collect procedure. The spill procedure determiner (712) represents programmed instructions that, when executed, cause the processing resources (702) to a completion time for the spill procedure. The merge procedure determiner (714) represents programmed instructions that, when executed, cause the processing resources (702) to determine a completion time for the merge procedure. The shuffle procedure determiner (716), represents programmed instructions that, when executed, cause the processing resources (702) to determine a completion time for a shuffle procedure. The write procedure determiner (718) represents programmed instructions that, when executed, cause the processing resources (702) to determine a completion time for a write procedure.

The input per map parameter variation applier (720) represents programmed instructions that, when executed, cause the processing resources (702) to apply a variation of the input per map parameter. The map selectivity parameter variation applier (722) represents programmed instructions that, when executed, cause the processing resources (702) to apply a variation of the map selectivity parameter. The number of map parameter variation applier (724) represents programmed instructions that, when executed, cause the processing resources (702) to apply a variation of the number of map parameter. The number of reduce parameter variation applier (726) represents programmed instructions that, when executed, cause the processing resources (702) to apply a variation of the number of reduce parameter.

The platform profile creator (728) represents programmed instructions that, when executed, cause the processing resources (702) to create a platform profile. The platform performance model creator (730) represents programmed instructions that, when executed, cause the processing resources (702) to create a platform performance model. The compact job profile creator (732) represents programmed instructions that, when executed, cause the processing resources (702) to create a compact job profile. The MapReduce performance model creator (734) represents programmed instructions that, when executed, cause the processing resources (702) to create a MapReduce performance model.

Further, the memory resources (704) may be part of an installation package. In response to installing the installation package, the programmed instructions of the memory resources (704) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (702) and the memory resources (704) are located within the same physical component, such as a server, or a network component. The memory resources (704) may be part of the physical component's main memory, caches, registers, non-volatile memory, or elsewhere in the physical component's memory hierarchy. Alternatively, the memory resources (704) may be in communication with the processing resources (702) over a network. Further, the data structures, such as the libraries, may be accessed from a remote location over a network connection while the programmed instructions are located locally. Thus, the completion time system (700) may be implemented on a user device, on a server, on a collection of servers, or combinations thereof.

The completion time system (700) of FIG. 7 may be part of a general purpose computer. However, in alternative examples, the completion time system (700) is part of an application specific integrated circuit.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method for determining a completion time of a job in a distributed network environment, said method comprising:
determining completion times for a map task and a reduce task of a job; and
executing at least one test to collect a training dataset that characterizes said completion times of said map task and said reduce task.

2. The method of claim 1, wherein said map task includes a read procedure, a collect procedure, a spill procedure, and a merge procedure.

3. The method of claim 1, wherein said reduce task includes a shuffle procedure and a write procedure.

4. The method of claim 1, further comprising creating a platform profile to characterize profile completion times for said map task and said reduce task as a function of processed data.

5. The method of claim 1, further comprising creating a MapReduce performance model based on a platform profile and a platform performance model to determine said completion times in said distributed network environment given said job.

6. The method of claim 1, wherein executing at least one test to collect a training dataset that characterizes said completion times of said map task and said reduce task includes processing different amounts of data by varying at least one parameter.

7. The method of claim 6, wherein said at least one parameter includes an input size per map task parameter, a map selectivity parameter, a number of map tasks, a number of reduce tasks, or combinations thereof.

8. A system for determining a completion time of a job in a distributed network environment, said system comprising:
a determination engine to determine completion times of a map task and a reduce task of a job;
an execution engine to execute at least one test to collect a training dataset that characterizes said completion times of said map task and said reduce task; and
a creation engine to:
create a platform profile to characterize profile completion times for said map task and said reduce task as a function of processed data; and
create a compact job profile for at least one said job.

9. The system of claim 8, wherein said map task includes a read procedure, a collect procedure, a spill procedure, and a merge procedure.

10. The system of claim 8, wherein said reduce task includes a shuffle procedure and a write procedure.

11. The system of claim 8, wherein said creation engine is to further create a MapReduce performance model based on said platform profile and a platform performance model to determine said completion times in said distributed network environment given said job.

12. The system of claim 8, further comprising a variation engine to vary parameters of said test to collect said training dataset that characterizes said completion times for said map task and said reduce task wherein said parameters include a input size per map task parameter, a map selectivity parameter, a number of map tasks, or a number of reduce tasks.

13. A computer program product for determining a completion time of a job in a distributed network environment, comprising:
a non-transitory computer readable storage medium, said non-transitory computer readable storage medium comprising computer readable program code embodied therewith, said computer readable program code comprising program instructions that, when executed, causes a processor to:
determine completion times of a map task and a reduce task of a job;
execute at least one test to collect a training dataset that characterizes said completion times of said map task and said reduce task; and
create a platform profile to characterize profile completion times for said job map task and said reduce task as a function of processed data.

14. The product of claim 13, further comprising computer readable program code comprising program instructions that, when executed, causes said processor to create a compact job profile for at least one said job.

15. The product of claim 13, further comprising computer readable program code comprising program instructions that, when executed, causes said processor to create a MapReduce performance model based on said platform profile and a platform performance model to determine said completion times in said distributed network environment given said job.
